(19) United States
(12) Patent Application Publication
(10) Pub. No.: US 2026/0167092 A1
(43) Pub. Date: Jun. 18, 2026

(54) VEHICLE CONTROL SYSTEM

(71) Applicant: ISUZU MOTORS LIMITED, Yokohama-shi (JP)

(72) Inventor: Yuya HAGIHARA, Fujisawa-shi (JP)

(21) Appl. No.: 19/369,619

(22) Filed: Oct. 27, 2025

(30) Foreign Application Priority Data
Dec. 12, 2024 (JP) 2024-217435

(51) Int. Cl. B60Q 1/14; G06T 7/70; G06V 20/58; G06V 40/10; H05B 47/11; H05B 47/125

(52) U.S. Cl. CPC B60Q 1/143; G06T 7/70; G06V 20/58; G06V 40/10; H05B 47/11; H05B 47/125; B60Q 2300/314; B60Q 2300/32; G06T 2207/30196; G06T 2207/30252; G06V 2201/08

(57) ABSTRACT

A vehicle control system includes an imaging unit that generates a captured image obtained by capturing an image ahead in a traveling direction of the vehicle, an illuminance sensor that detects brightness around a vehicle, a detection unit that detects an object ahead in the traveling direction based on the captured image, an identification unit that identifies a relative position of the vehicle with respect to a tunnel in accordance with brightness around the vehicle when the tunnel is detected as the object, and a control decision unit that decides, in accordance with the identified relative position, at least one of a parameter of detection processing for detecting the object in the captured image and a state of a headlight of the vehicle.

### CROSS-REFERENCE TO RELATED APPLICATIONS

The present application claims priority to Japanese Patent Applications No. 2024-217435, filed on Dec. 12, 2024, contents of which are incorporated herein by reference in their entirety.

### BACKGROUND OF THE INVENTION

The present disclosure relates to a vehicle control system for controlling a plurality of functions of a vehicle.

Vehicles having a plurality of functions are known. Japanese Unexamined Patent Application Publication No. 2017-94965 discloses a vehicle including i) an imaging device that adjusts an exposure level at the time of image capture on the basis of a luminance value of a captured image when detecting an object in a captured image, and ii) an automatic lighting device that automatically turns on headlights of the vehicle when the outside of the vehicle becomes dark.

Each of a plurality of functions mounted on the vehicle is controlled individually, and therefore the timing at which control is switched differs from one function to another. In particular, when the vehicle enters or exits a tunnel, it sometimes occurs that the

exposure level is adjusted to correspond to a bright exit while the vehicle is traveling near the tunnel exit, or that the headlights are turned on only after the vehicle has entered the tunnel.

### BRIEF SUMMARY OF THE INVENTION

The present disclosure focuses on this point, and an object thereof is to appropriately control i) processing for detecting an object in a captured image and ii) headlights when the vehicle enters or exits a tunnel.

An aspect of the present disclosure provides a vehicle control system that includes an illuminance sensor that detects brightness around a vehicle, an imaging unit that generates a captured image obtained by capturing an image ahead in a traveling direction of the vehicle. a detection unit that detects an object ahead in the traveling direction based on the captured image, an identification unit that identifies a relative position of the vehicle with respect to a tunnel in accordance with brightness around the vehicle when the detection unit detects the tunnel as the object, and a control decision unit that decides, in accordance with the identified relative position, at least one of a parameter of detection processing for detecting the object in the captured image and a state of a headlight of the vehicle.

### BRIEF DESCRIPTION OF THE DRAWINGS

FIG. 1 illustrates a configuration of a vehicle control system.

FIG. 2 schematically shows a state in which a vehicle approaches a tunnel.

FIG. 3 is a data table showing conditions for identifying a relative position.

FIG. 4 schematically shows a state in which the vehicle is traveling in a tunnel.

FIG. 5 schematically shows a state in which the vehicle is traveling near the exit of the tunnel.

FIG. 6 schematically shows a state in which the vehicle exits the tunnel.

FIG. 7 is an example of a data table in which a relative position and control are associated with each other.

FIG. 8 is a flowchart showing an example of identification processing.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Configuration of Vehicle Control System S

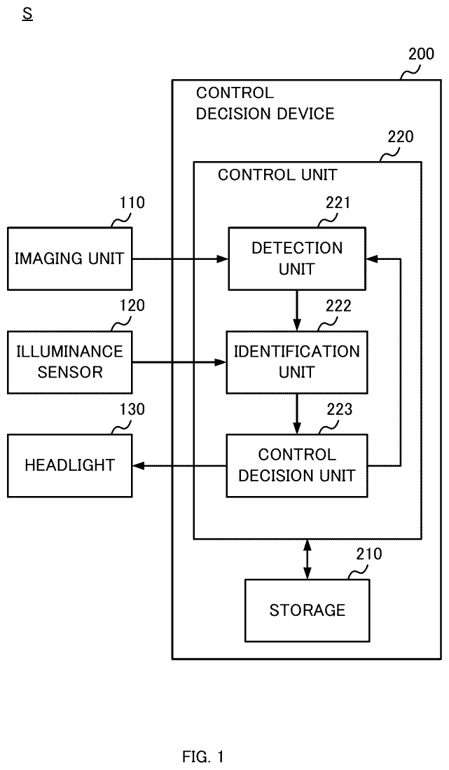

FIG. 1 illustrates a configuration of a vehicle control system S. The vehicle control system S is a system that is mounted on a vehicle and controls a plurality of devices mounted on the vehicle. The vehicle control system S includes an imaging unit 110, an illuminance sensor 120, headlights 130, and a control decision device 200.

The imaging unit 110 is a camera that generates a captured image obtained by capturing an image ahead in a traveling direction of the vehicle. The imaging unit 110 is provided at a position inside the vehicle capable of capturing an image ahead in the traveling direction of the vehicle, for example. Specifically, the imaging unit 110 is provided within a predetermined distance from an upper end of a windshield of the vehicle or within the predetermined distance from a lower end of the windshield of the vehicle. The predetermined distance is 150 millimeters, for example, but is not limited thereto.

The illuminance sensor 120 detects brightness around the vehicle. The illuminance sensor 120 detects illuminance as the brightness around the vehicle, for example. Illuminance is a physical quantity representing the brightness of light illuminating a surface of an object, and its unit is lux. The illuminance sensor 120 includes a first illuminance sensor and a second illuminance sensor. The first illuminance sensor is provided at a position capable of detecting the illuminance above the vehicle, and detects the illuminance above the vehicle. The first illuminance sensor is provided at the lower end of the windshield or a dashboard of the vehicle. The second illuminance sensor is provided at a position capable of detecting the illuminance ahead in the traveling direction, and detects the illuminance ahead in the traveling direction. The second illuminance sensor is provided on a front-end panel of the vehicle. The second illuminance sensor is provided between the two headlights 130 that are provided on the front-end panel.

The headlights 130 are attached to a front portion of the vehicle. The headlights 130 are lights that illuminate an area ahead in the traveling direction of the vehicle. The headlights 130 are turned on or off under the control of the control decision device 200.

The control decision device 200 decides control of the vehicle when the vehicle enters and exits the tunnel. The control decision device 200 turns on the headlights 130 when a tunnel is detected in a captured image. Further, upon the vehicle entering the tunnel, the control decision device 200 changes a parameter of detection processing for detecting an object ahead in the traveling direction in a captured image to a parameter used when the vehicle is traveling inside the tunnel. The control decision device 200 turns off the headlights 130 after the vehicle exits the tunnel. After the vehicle exits the tunnel, the control decision device 200 changes the parameter of detection processing to a parameter used when the vehicle is traveling outside (outside the tunnel). As described above, when the vehicle enters and exits the tunnel, the control decision device 200 i) controls the turning on and off of the headlights 130 and ii) changes the parameter of detection processing for detecting an object ahead in the traveling direction.

A specific configuration of the control decision device 200 will be described below.

### [Detailed Configuration of Control Decision Device 200]

The control decision device 200 includes a storage 210 and a control unit 220. The storage 210 is a storage medium including a Read Only Memory (ROM), a Random Access Memory (RAM), a hard disk, and the like. The storage 210 stores a program executed by the control unit 220.

The control unit 220 is a calculation resource including a processor such as a Central Processing Unit (CPU). The control unit 220 implements functions of a detection unit 221, an identification unit 222, and a control decision unit 223 by executing the program stored in the storage 210.

The detection unit 221 executes the detection processing for detecting an object ahead in the traveling direction based on a captured image obtained by capturing an image ahead in the traveling direction of the vehicle. For example, the detection unit 221 detects an object ahead in the traveling direction based on luminance values of pixels included in a captured image. Specifically, the detection unit 221 detects an object in a captured image based on pixels having luminance values within a threshold range for object detection in the captured image. More specifically, when a shape defined by a plurality of pixels having luminance values within the threshold range corresponding to a type of object substantially matches a shape of the object of that type, the detection unit 221 detects the object of that type located ahead in the traveling direction. The type of object includes, but is not limited to, a tunnel, a vehicle, and a pedestrian. In addition, the detection unit 221 is not limited to the above, and can detect an object using other known techniques.

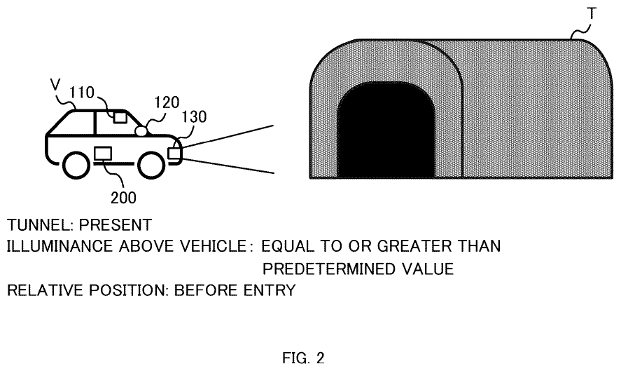

When the vehicle approaches the tunnel, the detection unit 221 detects the tunnel as the object ahead in the traveling direction in the captured image. FIG. 2 schematically shows a state in which a vehicle V approaches a tunnel. T. In FIG. 2, the vehicle V is in a state prior to entering the tunnel T. If pixels having luminance values within a threshold range corresponding to the tunnel T are included in the captured image, the detection unit 221 detects the tunnel T located ahead in the traveling direction. Specifically, when a shape of a region defined by a plurality of pixels having luminance values within the threshold range corresponding to the tunnel T substantially matches a shape of an entrance of the tunnel T, the detection unit detects the tunnel T as the object ahead in the traveling direction. The threshold range corresponding to the tunnel T may be appropriately set based on an experiment or the like and, for example, is from at least a minimum luminance value (specifically, 0) included in the captured image to no more than 20% of a maximum luminance value.

When the tunnel T is detected as the object in the captured image, the identification unit 222 identifies a relative position of the vehicle V with respect to the detected tunnel T. Here, situations in which identification of the relative position of the vehicle V with respect to the tunnel T is unnecessary will be described. For example, when the vehicle V is not traveling forward, the vehicle V does not enter the tunnel T, and therefore the control decision device 200 does not need to decide control to be performed upon entry into and exit from the tunnel T. Further, when it is nighttime, the outside is darker than the inside of the tunnel T, and the state of the headlights 130 of the vehicle V and the parameter of detection processing are controlled so as to correspond to nighttime outside conditions that are darker than those inside the tunnel T. Therefore, when it is nighttime, the control decision device 200 does not need to change the state of the headlights 130 and the parameter of detection processing at the time when the vehicle V enters or exits the tunnel T. Therefore, upon detecting the tunnel T as the object in the captured image, when the vehicle V is traveling forward and it is daytime, the identification unit 222 performs processing to identify the relative position of the vehicle V with respect to the tunnel T. Hereinafter, the processing to identify the relative position of the vehicle V with respect to the tunnel T is referred to as identification processing.

First, the identification unit 222 determines whether or not the vehicle V is traveling forward. When the vehicle speed of the vehicle V is greater than zero, and a shift position of the vehicle V is drive (D), the identification unit 222 determines that the vehicle V is traveling forward. The identification unit 222 determines that the vehicle V is not traveling forward when the vehicle V is stopped or traveling backward. When the vehicle speed of the vehicle V is zero or less, the identification unit 222 determines that the vehicle V is not traveling forward. Further, when the shift position is not drive (D), in other words, when the shift position is at least one of neutral (N), reverse (R), or parking (P), the identification unit 222 determines that the vehicle V is not traveling forward.

Next, the identification unit 222 determines whether or not it is daytime based on a detection value of the illuminance sensor 120. If the illuminance ahead in the traveling direction of the vehicle V, which is detected by the illuminance sensor 120, is equal to or greater than a threshold value, the identification unit 222 determines that it is daytime. The threshold value is a value for determining whether or not it is daytime, and is specifically 20,000 lux, but is not limited thereto. Specifically, the identification unit 222 determines that it is daytime if the second illuminance sensor of the two sensors included in the illuminance sensor 120, which detects illuminance ahead in the traveling direction, measures illuminance due to sunlight-band light, contained in the detected light, that is equal to or greater than the threshold value. If the illuminance ahead in the traveling direction is lower than the threshold value, the identification unit 222 determines that it is nighttime.

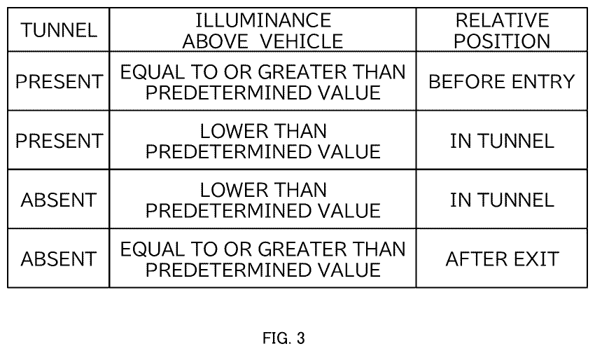

If the vehicle V is stopped or traveling backward, or if it is nighttime, the identification unit 222 determines that a condition for executing the identification processing is not satisfied, and does not execute the identification processing. If the vehicle V is traveling forward and it is daytime, the identification unit 222 determines that the condition for executing the identification processing is satisfied and executes the identification processing. Hereinafter, the identification processing for identifying the relative position executed by the identification unit 222 will be specifically described with reference to FIG. 3. FIG. 3 is a data table showing conditions for identifying the relative position.

When executing the identification processing, the identification unit 222 determines whether or not the illuminance above the vehicle V is equal to or greater than the threshold value. In a state in which the tunnel T is detected in the captured image (tunnel [present]), if the illuminance above the vehicle V detected by the illuminance sensor 120 is equal to or greater than the predetermined value, the identification unit 222 identifies the relative position as a position before entry into the tunnel T. Specifically, the identification unit 222 refers to the data table and identifies the relative position as [before entry], which is associated with the tunnel [present] and the illuminance above the vehicle V [equal to or greater than predetermined value]. This is because when the tunnel T is detected as the object in the captured image and an area above the vehicle V is bright, it can be said that the vehicle V is at a position before entry into the tunnel T. The predetermined value is a value for determining whether or not the vehicle V is outside the tunnel T. The predetermined value is, for example, a value used to determine that it is daytime outside under clear weather, and is specifically 20,000 lux, but is not limited thereto. While the tunnel T is detected in the captured image and the illuminance above the vehicle V detected by the illuminance sensor 120 is equal to or greater than the predetermined value, the identification unit 222 continues to identify that the relative position is before entry into the tunnel T.

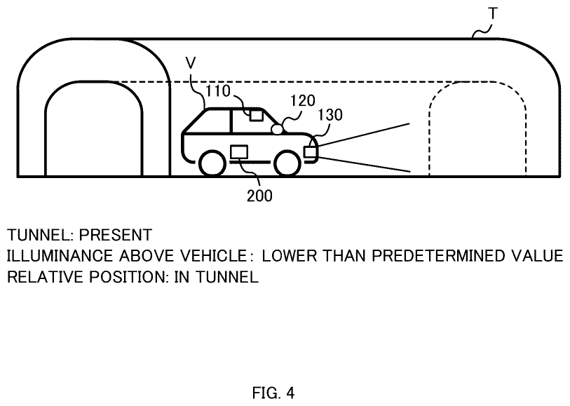

The vehicle V continues to travel and enters the tunnel T. FIG. 4 schematically shows a state in which the vehicle V is traveling inside the tunnel T. When the vehicle V enters the tunnel T, the detection unit 221 detects the presence of the tunnel T by detecting, in the captured image, a wall of the tunnel T as the object ahead in the traveling direction. Specifically, if a shape of a region formed by a plurality of pixels having luminance values within a threshold range corresponding to the wall of the tunnel T substantially matches a shape of the wall of the tunnel T, the detection unit 221 detects the tunnel T as the object ahead in the traveling direction. On the other hand, when the vehicle V enters the tunnel T, an area above the vehicle V becomes dark, and thus the illuminance above the vehicle V detected by the illuminance sensor 120 becomes lower than the predetermined value.

The illuminance above the vehicle V in the tunnel T is equal to or lower than a determination value, which is lower than the predetermined value, and equal to or greater than the minimum illuminance set for the tunnel T. The determination value is set to 500 lux, which is lower than daytime outside illuminance in rainy conditions (approximately 5,000 lux), which is lower than daytime outside illuminance in clear conditions (approximately 20,000 lux), but is not limited thereto. The minimum illuminance is 10 lux, for example, but is not limited thereto.

When the tunnel T is detected in the captured image (tunnel [present]) and the illuminance above the vehicle V becomes lower than the determination value, which is lower than the predetermined value, the identification unit 222 identifies the relative position as being a position inside the tunnel T due to entry of the vehicle V into the tunnel T. Specifically, the identification unit 222 refers to the data table and identifies the relative position as [in tunnel], which is associated with the tunnel [present] and the illuminance above the vehicle V [lower than the predetermined value].

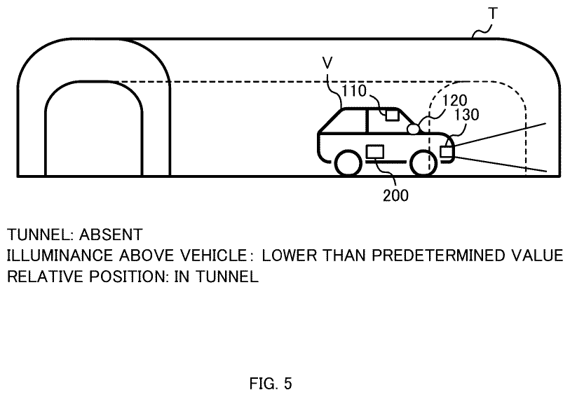

After the relative position is identified as being inside the tunnel T, the vehicle V approaches an exit of the tunnel T as the vehicle V continues to travel inside the tunnel T. FIG. 5 schematically shows a state in which the vehicle V is traveling near the exit of the tunnel T. As the vehicle V approaches the exit of the tunnel T, the detection unit 221 no longer detects the wall of the tunnel T and therefore no longer detects the tunnel T as the object ahead in the traveling direction. On the other hand, while the vehicle V is traveling inside the tunnel T, the illuminance above the vehicle V is lower than the determination value. Even when the detection unit 221 no longer detects the tunnel T in the captured image, the identification unit 222 continues to identify the relative position as being a position inside the tunnel T while the illuminance above the vehicle V is lower than the predetermined value. Specifically, while the tunnel is [absent] and the illuminance above the vehicle V is [lower than predetermined value], the identification unit 222 continues to identify the relative position as [in tunnel], which is associated with the tunnel [absent] and the illuminance above the vehicle V [lower than predetermined value] of the data table.

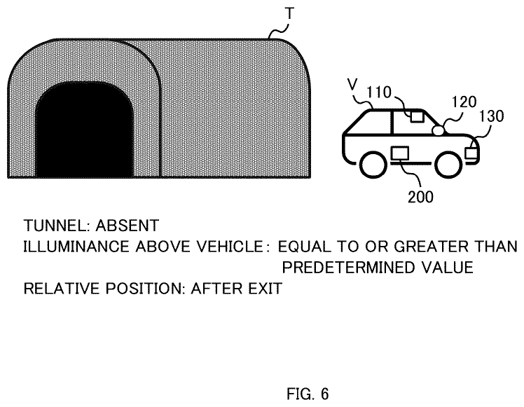

The vehicle V continues to travel and thereby exits the tunnel T through the exit. FIG. 6 schematically shows a state in which the vehicle V exits the tunnel T. When the vehicle V exits the tunnel T, the area above the vehicle V becomes brighter, and thus the illuminance above the vehicle V detected by the illuminance sensor 120 becomes equal to or greater than the predetermined value. When the tunnel T is no longer detected and the illuminance above the vehicle V becomes equal to or greater than the predetermined value, the identification unit 222 identifies the relative position as being a position after exiting the tunnel T due to the vehicle V having exited the tunnel T. When the tunnel is [absent] and the illuminance above the vehicle V is equal to or greater than the predetermined value, the identification unit 222 refers to the data table and identifies the relative position as [after exit], which is associated with the tunnel [absent] and the illuminance above the vehicle V [equal to or greater than predetermined value]. The identification unit 222 continues to identify the relative position as [after exit] until another tunnel T is detected as the object ahead in the traveling direction.

In this way, the identification unit 222 can appropriately identify the relative position of the vehicle V that passes through the tunnel T with respect to the tunnel T in accordance with i) whether or not the tunnel T is detected in the captured image and ii) the illuminance above the vehicle V. The identification unit 222 notifies the control decision unit 223 of the identified relative position.

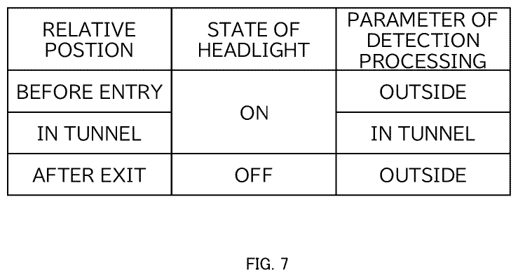

The control decision unit 223 decides control of the vehicle V based on the identified relative position. For example, the control decision unit 223 refers to a data table in which the relative position and the control are associated with each other and decides the control in accordance with the relative position. FIG. 7 is an example of the data table in which the relative position and the control are associated with each other.

The control decision unit 223 decides the state of the headlights 130 in accordance with the identified relative position. Specifically, when the relative position is identified as a position before entry into the tunnel T, the control decision unit 223 turns on the headlights 130. More specifically, when the relative position becomes [before entry], the control decision unit 223 sets the state of the headlights 130 to an [ON] state corresponding to the relative position [before entry]. Accordingly, the control decision unit 223 can turn on the headlights 130 before the vehicle V enters the tunnel T.

When the relative position is identified as a position inside the tunnel T, the control decision unit 223 turns on the headlights 130. When the relative position changes from [before entry] to [in tunnel], the control decision unit 223 maintains the headlights 130 in the [ON] state, which i) corresponds to the relative position [in tunnel] and ii) is the same as for [before entry]. Accordingly, the control decision unit 223 can continue to have the headlights 130 turned on while the vehicle V is traveling inside the tunnel T.

When the relative position is identified as a position after exiting the tunnel, the control decision unit 223 causes the headlights 130 to be an OFF state. When the relative position is changed from [in tunnel] to [after exit], the control decision unit 223 changes the headlights 130 to the [OFF] state corresponding to the relative position [after exit]. Accordingly, the control decision unit 223 can turn off the headlights 130 after the vehicle V exits the tunnel T.

The control decision unit 223 decides a parameter of detection processing for detecting the object ahead in the traveling direction of the vehicle V in accordance with the relative position. For example, the control decision unit 223 decides the parameter of detection processing executed by the detection unit 221 in accordance with the identified relative position. If the relative position is identified as [before entry] and [after exit], the control decision unit 223 sets the parameter of detection processing to a parameter corresponding to [outside]. If the relative position is identified as [in tunnel], the control decision unit 223 sets the parameter of detection processing to a parameter corresponding to [in tunnel]. The parameter of detection processing is, for example, a threshold range for detecting an other vehicle ahead in the traveling direction as the object in the captured image during the detection processing. As a specific example, if the relative position is identified as [before entry] and [after exit], the control decision unit 223 sets the threshold range of detection processing to a first threshold range corresponding to [outside]. If the relative position is identified as [in tunnel], the control decision unit 223 sets the threshold range of detection processing to a second threshold range corresponding to [in tunnel].

When the other vehicle traveling ahead in the traveling direction of the vehicle V traveling inside the tunnel T has its taillights turned on, luminance values of pixels within a region of the captured image where the taillights of the other vehicle appear are higher than luminance values of pixels within a region where areas other than the taillights are captured. Therefore, the control decision unit 223 makes the second threshold range wider than the first threshold range. Specifically, the control decision unit 223 makes the second threshold range wider than the first threshold range by making an upper limit value of the second threshold range higher than an upper limit value of the first threshold range. Accordingly, the detection unit 221 can easily detect, as a taillight, a pixel having a high luminance value among a plurality of pixels in a captured image captured while the vehicle V is traveling inside the tunnel T, and can therefore easily detect the other vehicle as the object ahead in the traveling direction.

It should be noted that the control decision unit 223 may decide not only the threshold range for detecting the other vehicle as the object in the captured image during the detection processing but also the threshold range for detecting a pedestrian as the object in the captured image during the detection processing. Luminance values of pixels in a region of the captured image where a pedestrian inside the tunnel T is captured is smaller than luminance values of pixels in a region where a pedestrian outside is captured. Therefore, the control decision unit 223 sets a third threshold range for detecting a pedestrian inside the tunnel T in the captured image to be wider than a fourth threshold range for detecting a pedestrian outside in the captured image. More specifically, the control decision unit 223 sets a lower limit value of the third threshold range to be smaller than a lower limit value of the fourth threshold range. Accordingly, the detection unit 221 can easily detect a pedestrian inside the tunnel T, which is captured in a darker condition than outside.

### [Identification Processing for Identifying Relative Position]

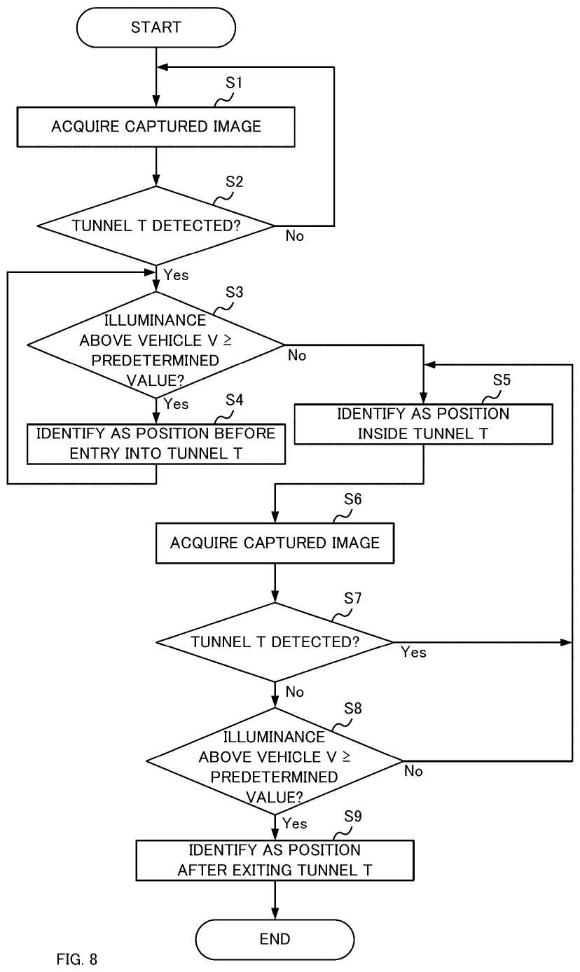

FIG. 8 is a flowchart showing an example of identification processing. The identification processing is executed at predetermined intervals while the vehicle V is traveling in the daytime. The predetermined interval is 100 milliseconds, for example, but is not limited thereto. Further, the illuminance sensor 120 appropriately detects the illuminance above the vehicle V.

The detection unit 221 acquires the captured image generated by the imaging unit 110 (step S1). The detection unit 221 detects the object ahead in the traveling direction in the captured image.

The identification unit 222 determines whether or not the detection unit 221 has detected the tunnel T as the object ahead in the traveling direction (step S2). If the detection unit 221 does not detect the tunnel T as the object ahead in the traveling direction (No in step S2), the identification unit 222 waits until the detection unit 221 detects the tunnel T as the object ahead in the traveling direction.

If the detection unit 221 detects the tunnel T as the object ahead in the traveling direction (Yes in step S2), the identification unit 222 determines whether or not the illuminance above the vehicle V detected by the illuminance sensor 120 is equal to or greater than the predetermined value (step S3). If the illuminance above the vehicle V is equal to or greater than the predetermined value (Yes in Step S3), the identification unit 222 identifies the relative position of the vehicle V with respect to the tunnel T as a position before entry into the tunnel T (Step S4). While the illuminance above the vehicle V is equal to or greater than the predetermined value, the identification unit 222 repeatedly executes step S3 and step S4, and continues to identify the relative position as a position before entry into the tunnel T.

If the illuminance above the vehicle V detected by the illuminance sensor 120 becomes lower than the predetermined value (No in step S3), the identification unit 222 identifies the relative position of the vehicle V with respect to the tunnel T as a position inside the tunnel T (step S5). If the relative position is identified as a position inside the tunnel T, the detection unit 221 acquires the captured image generated by the imaging unit 110 inside the tunnel T (step S6). The detection unit 221 detects the object ahead in the traveling direction in the captured image.

If the relative position of the vehicle V is identified as a position inside the tunnel T, the identification unit 222 determines whether or not the detection unit 221 has detected the tunnel T as the object ahead in the traveling direction (step S7). If the detection unit 221 detects the tunnel T as the object ahead in the traveling direction (Yes in step S7), the identification unit 222 returns to step S5 and identifies the relative position as a position inside the tunnel T.

If the detection unit 221 no longer detects the tunnel T as the object ahead in the traveling direction (No in step S7), the identification unit 222 determines whether or not the illuminance above the vehicle V detected by the illuminance sensor 120 is equal to or greater than the predetermined value (step S8). If the illuminance above the vehicle V detected by the illuminance sensor 120 is lower than the predetermined value (No in step S8), the identification unit 222 returns to step S5 and identifies the relative position as a position inside the tunnel T. If the illuminance above the vehicle V detected by the illuminance sensor 120 is equal to or greater than the predetermined value (Yes in step S8), the identification unit 222 identifies the relative position of the vehicle V with respect to the tunnel T as a position after exiting the tunnel T (step S9).

### [Effects of Vehicle Control System S]

As described above, when the tunnel T is detected as the object ahead in the traveling direction of the vehicle V based on the captured image obtained by capturing an image ahead in the traveling direction of the vehicle V, the vehicle control system S identifies the relative position of the vehicle V that passes through the tunnel T with respect to the tunnel T in accordance with the brightness around the vehicle V. Then, the vehicle control system S decides, in accordance with the identified relative position, at least one of a) the parameter of detection processing for detecting the object in the captured image and b) the state of the headlights 130 of the vehicle V.

Accordingly, the vehicle control system S can turn on the headlights 130 of the vehicle V before the vehicle V enters the tunnel T and turn off the headlights 130 after the vehicle exits the tunnel T, for example. In addition, the vehicle control system S can set the parameter of detection processing for detecting the object in the captured image when the vehicle V enters the tunnel T to a parameter corresponding to the inside of the tunnel T, and can set the parameter of detection processing to a parameter corresponding to the outside when the vehicle V exits the tunnel T. As described above, the vehicle control system S can appropriately control the detection processing for detecting the object in the captured image and the headlights 130 when the vehicle V enters or exits the tunnel T.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A vehicle control system comprising:
an illuminance sensor that detects brightness around a vehicle;
an imaging unit that generates a captured image obtained by capturing an image ahead in a traveling direction of the vehicle;
a detection unit that detects an object ahead in the traveling direction based on the captured image;
an identification unit that identifies a relative position of the vehicle with respect to a tunnel in accordance with brightness around the vehicle when the detection unit detects the tunnel as the object; and
a control decision unit that decides, in accordance with the identified relative position, at least one of a parameter of detection processing for detecting the object in the captured image and a state of a headlight of the vehicle.

2. The vehicle control system according to claim 1, wherein
the illuminance sensor detects brightness above the vehicle, and
when the detection unit detects the tunnel as the object, the identification unit identifies the relative position in accordance with whether or not the brightness above the vehicle is equal to or greater than a predetermined value for determining whether or not the vehicle is outside the tunnel.

3. The vehicle control system according to claim 2, wherein
the identification unit
identifies the relative position as a position before entry into the tunnel when the detection unit detects the tunnel as the object and the brightness above the vehicle is equal to or greater than the predetermined value, and
identifies the relative position as a position inside the tunnel when the detection unit detects the tunnel as the object and the brightness above the vehicle is lower than the predetermined value.

4. The vehicle control system according to claim 3, wherein
after identifying that the relative position as a position inside the tunnel, the identification unit continues to identify the relative position as a position inside the tunnel while the brightness above the vehicle is lower than the predetermined value after the detection unit no longer detects the tunnel.

5. The vehicle control system according to claim 3, wherein
after identifying that the relative position is a position inside the tunnel, the identification unit identifies that the relative position is a position after exiting the tunnel when the detection unit no longer detects the tunnel and the brightness above the vehicle is equal to or greater than the predetermined value.

6. The vehicle control system according to claim 3, wherein
the control decision unit turns on the headlight when the relative position is identified as a position before entry into the tunnel.

7. The vehicle control system according to claim 5, wherein
the control decision unit turns off the headlight when the relative position is identified as a position after exiting the tunnel.

8. The vehicle control system according to claim 3, wherein
the detection unit performs the detection processing for detecting an other vehicle in the captured image based on pixels having luminance values within a threshold range for detecting the other vehicle as the object in the captured image, and
the control decision unit sets a second threshold range, which is the threshold range in a case where the relative position is a position inside the tunnel, to be wider than a first threshold range, which is the threshold range in a case where the relative position is a position before entry into the tunnel.

9. The vehicle control system according to claim 5, wherein
the detection unit performs the detection processing for detecting an other vehicle in the captured image based on pixels having luminance values within a threshold range for detecting the other vehicle as the object in the captured image, and
the control decision unit sets a second threshold range, which is the threshold range in a case where the relative position corresponds to a position inside the tunnel, to be wider than a first threshold range, which is the threshold range in a case where the relative position is a position after exiting the tunnel.

10. The vehicle control system according to claim 1, wherein
the detection unit performs the detection processing for detecting the object in the captured image based on pixels having luminance values within a threshold range for detecting a pedestrian as the object in the captured image, and
the control decision unit sets a lower limit value of a third threshold range which is the threshold range for detecting a pedestrian inside the tunnel in the captured image to be smaller than a lower limit value of a fourth threshold range which is the threshold range for detecting a pedestrian outside in the captured image.

11. The vehicle control system according to claim 1, wherein
the identification unit
identifies the relative position of the vehicle with respect to the tunnel when the vehicle is traveling forward and the brightness ahead in the traveling direction of the vehicle detected by the illuminance sensor is equal to or greater than a threshold value for determining whether the vehicle is in the daytime, and
does not identify the relative position of the vehicle with respect to the tunnel when the vehicle is not traveling forward or the brightness ahead in the direction of travel is lower than the threshold value.
